(19) United States
(12) Patent Application Publication
(10) Pub. No.: US 2016/0227494 A1
(43) Pub. Date: Aug. 4, 2016

(54) METHOD AND APPARATUS TO DETERMINE A TRANSMISSION TIME OF A WIRELESS DATA FRAME

(71) Applicant: QUALCOMM Incorporated, San Diego, CA (US)

(72) Inventors: Manishekar Chandrasekaran, Hyderabad (IN); Ganesh Kondabattini, Hyderabad (IN)

(21) Appl. No.: 14/611,813

(22) Filed: Feb. 2, 2015

(51) Int. Cl. H04W 56/00

(52) U.S. Cl. CPC H04W 56/001

(57) ABSTRACT

A method and apparatus are disclosed for transmitting a data frame from a first wireless device to a second wireless device based, at least in part, on timing information received from the second wireless device. In some embodiments, the timing information may be included within an informational element transmitted to the first wireless device. In some embodiments, the informational element may be included with a probe request, probe response or action frame.

### TECHNICAL FIELD

The present embodiments relate generally to wireless networks, and specifically determining a transmission time of a wireless data frame.

### BACKGROUND OF RELATED ART

A peer-to-peer (P2P) network may include two or more wireless devices. To establish the P2P network, a first wireless device may search for a suitable second wireless device. After locating the second wireless device, the first and the second wireless devices may proceed with a group owner negotiation process to determine a P2P Group Owner. The P2P Group Owner performs certain administration tasks such as beacon transmissions and P2P client admission.

The first wireless device may search for and locate the second wireless device by transmitting a Wi-Fi message that is successfully received by the second wireless device. However, since the second wireless device may have an unknown “listening time” (e.g., an unknown receiver schedule), the message transmitted by the first wireless device may not be received by the second wireless device. In some cases, the search and locate procedure may be repeated several times until the Wi-Fi message is successfully received by the second wireless device. Repeating the search and locate procedure extends the time needed to establish the P2P network, increases power consumption, and may provide a negative user experience.

Thus, there is a need to improve the reception of a wireless transmission by a wireless device, for example, to reduce the time needed to establish a P2P network.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

A device and method of exchanging data frames between a first wireless device and a second wireless device is disclosed. In accordance with some embodiments, the first wireless device may receive a first data frame including timing information from the second wireless device. The first wireless device may transmit an acknowledgement message to the second wireless device based, at least in part, on the first data frame. The first wireless device may determine a transmit time to transmit a second data frame to the second wireless device based, at least in part, on the timing information and transmit the second data frame at the determined transmit time.

### BRIEF DESCRIPTION OF THE DRAWINGS

The present embodiments are illustrated by way of example and are not intended to be limited by the figures of the accompanying drawings. Like numbers reference like elements throughout the drawings and specification.

FIG. 1 depicts an example system within which the present embodiments may be implemented.

FIG. 2 is an example sequence diagram for synchronizing STAs in accordance with some embodiments.

FIG. 3 depicts a diagram of an informational element including timing information, according to some embodiments.

FIG. 4 shows a wireless device that is one embodiment of the stations STA 1 and STA 2 of FIG. 1.

FIG. 5 shows an illustrative flow chart depicting an example operation for transmitting data between a first wireless device and a second wireless device, in accordance with some embodiments.

### DETAILED DESCRIPTION

The present embodiments are described below in the context of Wi-Fi enabled devices for simplicity only. It is to be understood that the present embodiments are equally applicable for devices using signals of other various wireless standards or protocols. As used herein, the terms “wireless local area network (WLAN)” and “Wi-Fi” can include communications governed by the IEEE 802.11 standards, BLUETOOTH®, HiperLAN (a set of wireless standards, comparable to the IEEE 802.11 standards, used primarily in Europe), and other technologies used in wireless communications.

In the following description, numerous specific details are set forth such as examples of specific components, circuits, and processes to provide a thorough understanding of the present disclosure. The term “coupled” as used herein means coupled directly to or coupled through one or more intervening components or circuits. Also, in the following description and for purposes of explanation, specific nomenclature is set forth to provide a thorough understanding of the present embodiments. However, it will be apparent to one skilled in the art that these specific details may not be required to practice the present embodiments. In other instances, well-known circuits and devices are shown in block diagram form to avoid obscuring the present disclosure. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The present embodiments are not to be construed as limited to specific examples described herein but rather to include within their scope all embodiments defined by the appended claims.

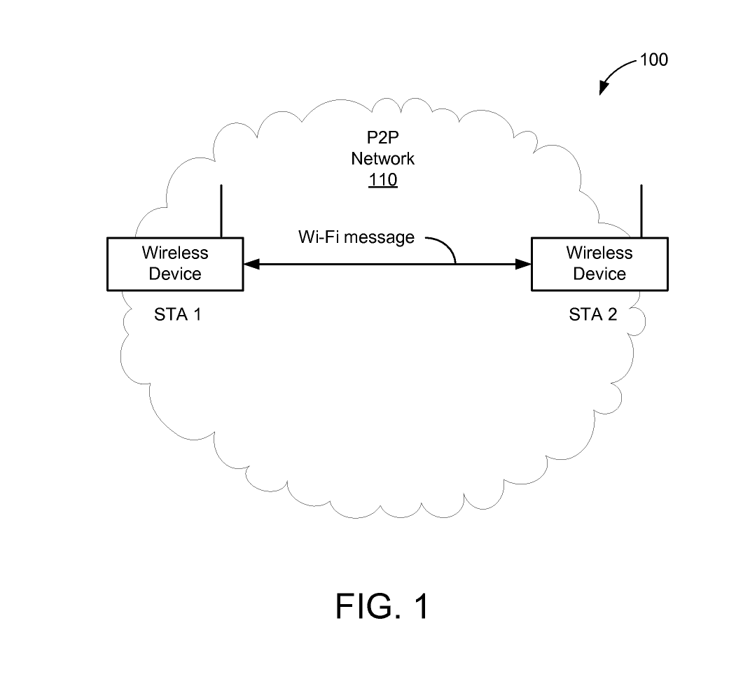

FIG. 1 depicts an example system 100 within which the present embodiments may be implemented. The system 100 may include two wireless devices that operate within a peer-to-peer (P2P) network 110. In other embodiments, the wireless devices may operate in an infrastructure network (not shown for simplicity). Although only two wireless devices are shown in FIG. 1 for simplicity, it is to be understood that the system 100 may include any number of wireless devices. One or more of the wireless devices may be a suitable wireless communication device such as, for example, a cell phone, desktop computer, laptop computer, tablet computer, wireless access point, or the like.

The wireless devices included in P2P network 110 may include a first station (STA 1) and a second station (STA 2). To establish P2P network 110, STA 1 and STA 2 may operate in a discovery mode where they become aware of each other by exchanging a message, such as a Wi-Fi message. For example, a Wi-Fi message may be transmitted from STA 1 and may be received by STA 2. In another embodiment, a Wi-Fi message may be transmitted from STA 2 and received by STA 1. During the discovery mode, STA 1 may not be aware of an operating schedule of STA 2, and STA 2 may not be aware of the operating schedule of STA 1. As a result, STA 1 may transmit the Wi-Fi message when STA 2 may not be in a listening mode (e.g., operating a Wi-Fi receiver). The discovery mode may be extended to allow this transmit/receive cycle to repeat until the Wi-Fi message is successfully received. Extending the discovery mode may negatively affect a user's experience by delaying an establishment of P2P network 110.

To reduce the time associated with the discovery mode, timing information associated with an STA may be transmitted along with a data frame from the STA. For example, timing information may include an operating schedule associated with the STA. In some embodiments, the timing information may be included in informational elements that may be transmitted within a variety of data frames including, for example, probe requests, probe responses, action frames, beacons, and any other technically feasible data frames.

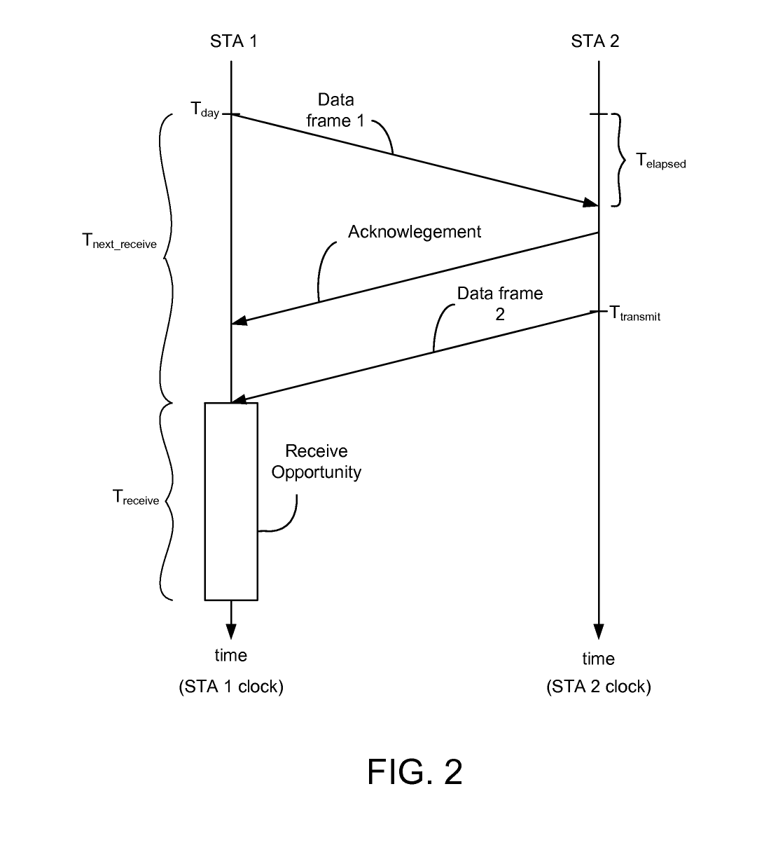

FIG. 2 is an example sequence diagram 200 for synchronizing STAs in accordance with some embodiments. For ease of discussion of the example depicted in FIG. 2, STA 2 determines a transmit time to align with a receive opportunity associated with STA 1. In other embodiments, STA 1 may determine a transmit time to align with a receive opportunity associated with STA 2 (not shown for simplicity). In some embodiments, STA 2 may determine the transmit time (Tₜᵣₐₙₛₘᵢₜ) using timing information provided by STA 1. The timing information may be included with some or all of the data frames transmitted by STA 1. In some embodiments, the timing information may be included as informational elements included with transmitted data frames.

STA 1 and STA 2 may each include a clock (STA 1 clock and STA 2 clock, respectively). In some embodiments, STA 1 clock and STA 2 clock may be a time of day clock with millisecond accuracy. STA 1 may transmit a first data frame at STA 1 clock=T_{day}. STA 1 may also schedule a time to receive a second data frame from STA 2 at a time offset from T_{day}. The time offset may be denoted as Tₙₑₓₜ_{_}_{receive}. For example, after transmitting the first data frame at STA 1 clock=T_{day}, STA 1 may wait Tₙₑₓₜ_{_}_{receive} seconds, and then enable its Wi-Fi receiver to receive the second data frame from STA 2. The Wi-Fi receiver may be operated for a duration of T_{receive} seconds. In some embodiments, Tₙₑₓₜ_{_}_{receive} and/or T_{receive} may be expressed in milliseconds. In some embodiments, by transmitting timing information (e.g., T_{day}, Tₙₑₓₜ_{_}_{receive} , T_{receive}) from STA 1 to STA 2, STA 2 may determine when to transmit the second data frame (e.g., determine Tₜᵣₐₙₛₘᵢₜ) such that the second data frame may be successfully received by STA 1 (e.g., when STA 1 is scheduled to be in a listening state).

The STA 1 clock and STA 2 clock may be independent clocks and may be offset from each other by an amount. Thus, although the clocks of STA 1 and STA 2 may track each other (for example, within a tracking tolerance), absolute values of the two clocks may be different. Transmitted timing information may be used to resolve clock differences and determine an accurate Tₜᵣₐₙₛₘᵢₜ time for transmitting the second data frame from STA 2 to STA 1.

In some embodiments, Tₜᵣₐₙₛₘᵢₜ may be determined by eq. 1, as shown below:

Tₜᵣₐₙₛₘᵢₜ=Tₙₑₓₜ_{_}_{receive}−T_{elapsed} (eq. 1)

where:
Tₜᵣₐₙₛₘᵢₜ is the time when a data frame (e.g., the second data frame) is to be transmitted from STA 2 to STA 1;
Tₙₑₓₜ_{_}_{receive} is a time period between transmitting the first data frame from STA 1 at time=T_{day} and enabling the Wi-Fi receiver of STA 1; and
T_{elapsed} is an elapsed time between when the data frame was transmitted by STA 1 and may be received by STA 2.

In one embodiment, T_{elapsed} may be determined by eq. 2, as shown below:

T_{elapsed}=[(current time)−T_{day}] (eq. 2)

where:
Current time is the time value (clock) of the STA 2 clock; and
T_{day} is the time value (clock) of the STA 1 clock when the first data frame is transmitted.

Thus, substituting eq. 2 into eq. 1, Tₜᵣₐₙₛₘᵢₜ may be determined by eq. 3, as shown below:

Tₜᵣₐₙₛₘᵢₜ=Tₙₑₓₜ_{_}_{receive}[(current time)−T_{day}] (eq. 3)

For example, STA 1 may have a Tₙₑₓₜ_{_}_{receive} of 120 milliseconds (ms) and a T_{receive} of 10 ms. At T_{day}=0 ms, STA 1 may transmit the first data frame to STA 2 and may include timing information associated with STA 1. Thus, the timing information may include T_{day}=0 ms, Tₙₑₓₜ_{_}_{receive}=120 ms, and T_{receive}=10 ms. For the sake of discussion, if the current time at STA 2 is 10 ms (e.g. STA 2 clock=10 ms), then Tₜᵣₐₙₛₘᵢₜ is 110 ms. Note that in this example, Tₜᵣₐₙₛₘᵢₜ is described in terms of the clock of STA 2. Since T_{receive}=10 ms, Tₜᵣₐₙₛₘᵢₜ may be extended to 120 ms (e.g., Tₜᵣₐₙₛₘᵢₜ+T_{receive}) and may still allow the second data frame to arrive at STA 1 within the T_{receive} duration.

In some embodiments, T_{elapsed} values may be adjusted to increase the accuracy of Tₜᵣₐₙₛₘᵢₜ. For example, information regarding a clock offset between STA 1 clock and STA 2 clock may be factored into T_{elapsed}. Also, additional time may be added to T_{elapsed} to account for a crowded or busy communication medium and/or for processing delays associated with transmitting and/or receiving a data frame. A second embodiment of T_{elapsed} is described by eq. 4, shown below:

T_{elapsed}=[(current time+T_{delta}+T_{buffer})−T_{day}] (eq. 4)

where:
T_{delta} is a difference between STA 1 clock and STA 2 clock (based on a previously received data frame); and
T_{buffer} is an additional amount of time that may be used to account for communication medium congestion and/or processing delays associated with STA 1 and/or STA 2.

By substituting eq. 4 into eq. 1, Tₜᵣₐₙₛₘᵢₜ may be determined by eq. 5 as shown below:

Tₜᵣₐₙₛₘᵢₜ=Tₙₑₓₜ_{_}_{receive} [(current time+T_{delta}+T_{buffer})−T_{day}] (eq. 5)

T_{delta} may describe a difference between the clocks of STA 1 and STA 2. Thus, T_{delta} may indicate how much STA 1 clock is ahead of or behind STA 2 clock. Values of T_{delta} may be positive or negative. In some embodiments, T_{delta} may be based on timing information included with previously received data frames. An initial value of T_{delta} may be zero since there may be no previously received data frames. If T_{delta} is associated with a broadcast data frame (e.g., beacon frame), then T_{delta} may be set to zero or ignored.

In some embodiments, T_{buffer} may be set to an initial value by hardware, software or firmware. For example, an initial value of a processing delay may be determined by bench tests or by a test performed when the STA is initialized. In another embodiment, T_{buffer} may be dynamically adjusted in response to detected network conditions. For example, the STA may determine that the communication medium is becoming crowded, and in response thereto, may update the value for T_{buffer}.

In some embodiments, determining Tₜᵣₐₙₛₘᵢₜ may be simplified when STA 1 and STA 2 are synchronized to and/or use a common reference clock such as one described by a Network Time Protocol (NTP). For example, using the NTP may allow STA 1 and STA 2 to synchronize their respective clocks to within a few milliseconds of Coordinated Universal Time (UTC). When both STA 1 and STA 2 synchronize their clocks to a common reference clock, T_{delta} may be zero (or a relatively small value) and may be ignored.

For example, STA 1 may have a Tₙₑₓₜ_{_}_{receive} of 120 milliseconds (ms), a T_{receive} of 10 ms, a T_{delta} of 5 ms, and a T_{buffer} of 8 ms. At T_{day}=0 ms, STA 1 may transmit the first data frame to STA 2 and may include timing information associated with STA 1. For the sake of discussion, if the current time at STA 2 is 10 ms (e.g. STA 2 clock=10 ms), then Tₜᵣₐₙₛₘᵢₜ is 97 ms (120−(10+5+8)−0). Since T_{receive}=10 MS, Tₜᵣₐₙₛₘᵢₜ may be extended to 107 ms (e.g., Tₜᵣₐₙₛₘᵢₜ+T_{receive}) and may still allow the second data frame to arrive within the T_{receive} duration.

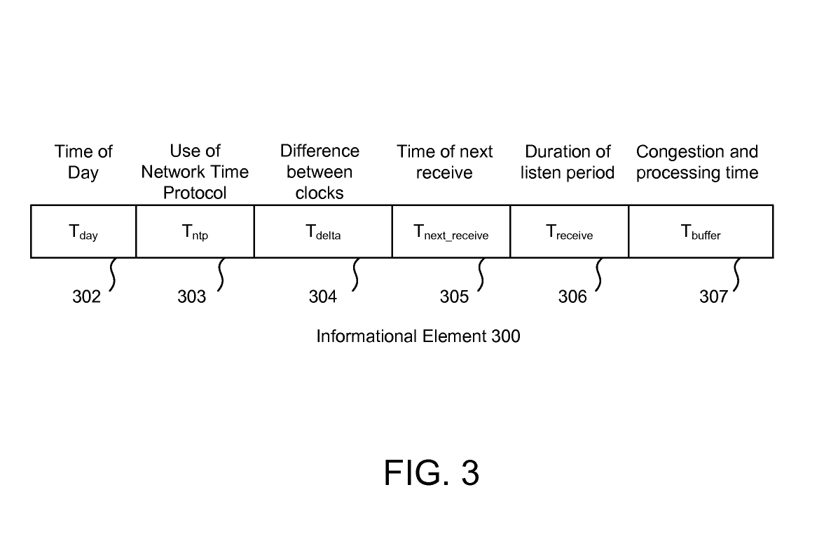

FIG. 3 depicts a diagram of an informational element 300 including timing information, according to some embodiments. Informational element 300 may be a vendor specific informational element that may be included within some or all data frames transmitted between wireless devices such as STAs. As described above, informational element 300 may include timing information describing clocks and/or scheduled events associated with a selected wireless device. For ease of discussion with respect to FIG. 3, STA 1 transmits informational element 300 to STA 2. In other embodiments, STA 2 may transmit informational element 300 to STA 1. Informational element 300 may include a time of day (T_{day}) field 302, an NTP field 303, a clock difference (T_{delta}) field 304, a next receive (Tₙₑₓₜ_{_}_{receive}) field 305, a receive duration (T_{receive}) field 306, and a time buffer (T_{buffer}) field 307. In other embodiments, informational element 300 may include a subset of fields 302-307 or fields 302-307 in a different order. In still other embodiments, informational element 300 may include other fields not described here.

T_{day} field 302 may describe a time when the first data frame is transmitted from STA 1. The time may be based on a clock, such as a time of day clock, included within STA 1. In some embodiments, the time described in T_{day} field 302 may be expressed in milliseconds.

NTP field 303 may indicate whether STA 1 is synchronized to a reference clock. In one embodiment, the reference clock may be specified by the Network Time Protocol. In some embodiments, when an STA is synchronized to a reference clock, the time described in T_{day} field 302 may be the reference clock.

T_{delta} field 304 may describe a difference between STA 1 clock and a clock within a different wireless device (e.g., STA 2 clock). As described above, STA 1 clock may track, with an offset, STA 2 clock. Thus, T_{delta} field 304 may describe how much STA 1 clock is ahead of or behind STA 2 clock. In some embodiments, values of T_{delta} field 304 may be positive or negative and/or may be expressed in milliseconds.

Tₙₑₓₜ_{_}_{receive} field 305 may describe a period of time between the transmission of the first data frame (e.g., the time described in T_{day} field 302) and the next time STA 1 is scheduled to enable its Wi-Fi receiver for receiving frames. For example, if Tₙₑₓₜ_{_}_{receive}=15 ms, then 15 ms after the first data frame is transmitted from STA 1, STA 1 may enable its Wi-Fi receiver. In some embodiments, Tₙₑₓₜ_{_}_{receive} field 305 may be expressed in milliseconds.

T_{receive} field 306 may describe a period of time that the Wi-Fi receiver of STA 1 is enabled. Thus, T_{receive} field 306 may describe a period of time that STA 1 may receive the second data frame from STA 2. In some embodiments, T_{receive} field 306 may be expressed in milliseconds.

T_{buffer} field 307 may describe an amount of “buffer” time to allow an adjustment of Tₜᵣₐₙₛₘᵢₜ to account for a busy or congested communication medium and/or transmit or receive processing delays. For example, if the communication medium is busy, then T_{buffer} may be increased from 0 ms to 10 ms to allow more time to access the medium. In some embodiments, T_{buffer} field 307 may be expressed in milliseconds.

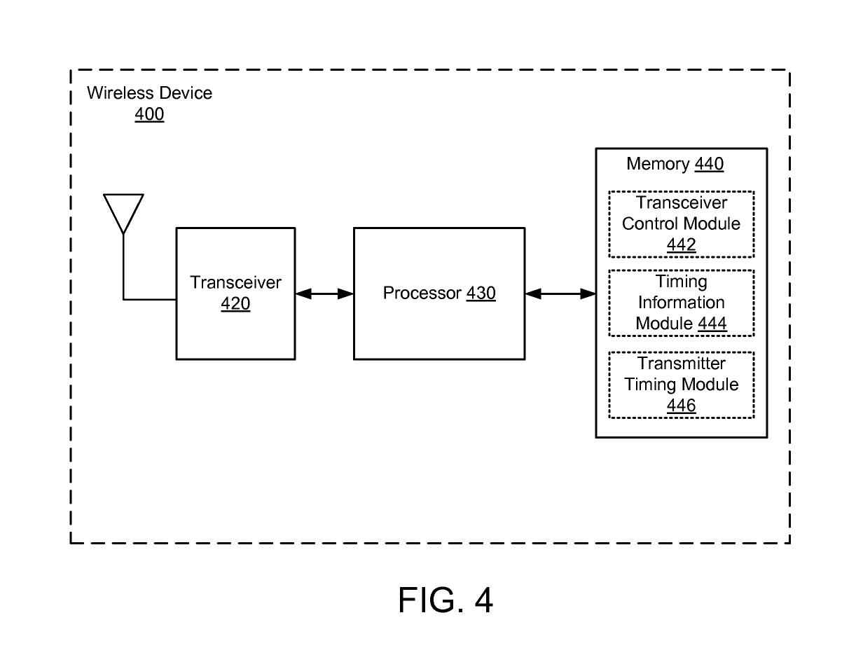

FIG. 4 shows wireless device 400 that is one embodiment of the stations STA 1 and STA 2 of FIG. 1. Wireless device 400 includes a transceiver 420, a processor 430, and a memory 440. Transceiver 420 may be used to transmit and receive signals to and from the APs and/or other STAs. In some embodiments, transceiver 420 may include one or more Wi-Fi transmitters and one or more Wi-Fi receivers (not shown for simplicity). In one embodiment, transceiver 420 may transmit and receive Wi-Fi messages according to an IEEE 802.11 specification. In other embodiments, transceiver 420 may transmit and receive wireless signals according to any technically feasible specification such as BLUETOOTH® and/or ZigBee.

Memory 440 may include a non-transitory computer-readable storage medium (e.g., one or more nonvolatile memory elements, such as EPROM, EEPROM, Flash memory, a hard drive, etc.) that may store the following software modules:
a transceiver control module 442 to control one or more transmissions from and/or receptions by transceiver 420;
a timing information module 444 to extract timing information from received data frames and to determine timing information to be included within transmitted data frames; and
a transmitter timing module 446 to determine when to transmit a data frame based on timing information (e.g., information extracted from received data frames).

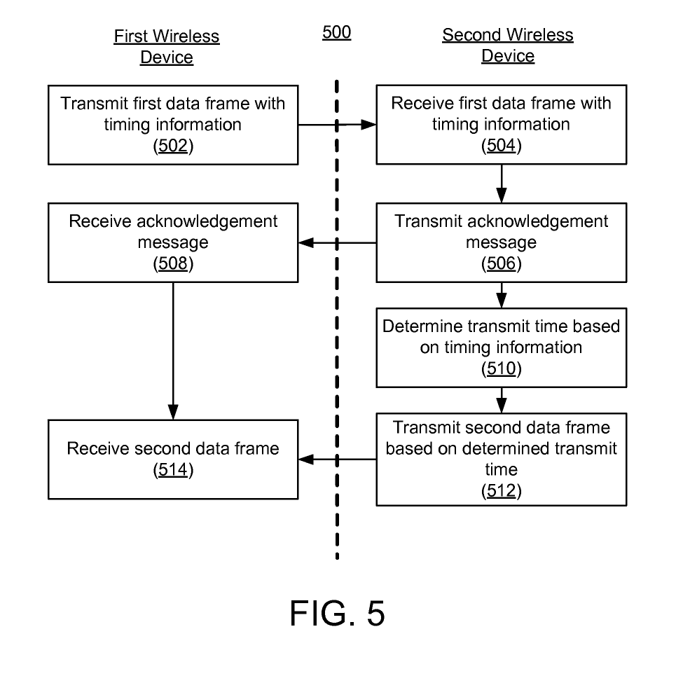

Each software module includes program instructions that, when executed by processor 430, may cause wireless device 400 to perform the corresponding function(s). Thus, the non-transitory computer-readable storage medium of memory 440 may include instructions for performing all or a portion of the operations of FIG. 5.

Processor 430, which is coupled to transceiver 420 and memory 440, may be any suitable processor capable of executing scripts or instructions of one or more software programs stored in wireless device 400 (e.g., within memory 440).

Processor 430 may execute transceiver control module 442 to transmit and/or receive wireless communication signals via transceiver 420. For example, transceiver control module 442 may operate a Wi-Fi receiver and/or a Wi-Fi transmitter (not shown for simplicity) within transceiver 420. Additionally, transceiver control module 442 may encode data to be transmitted by transceiver 420 and may decode data received from transceiver 420.

Processor 430 may execute timing information module 444 to determine timing information of an STA based on a data frame received by transceiver 420. For example, transceiver 420 may receive an informational element 300 included with the data frame. Timing information module 444 may be executed by processor 430 to determine timing information based on the received informational element 300. In some other embodiments, timing information module 444 may generate an informational element 300 based on timing information associated with wireless device 400. The informational element 300 may be transmitted with a data frame by transceiver 420.

Processor 430 may execute transmitter timing module 446 to determine when to transmit a data frame (e.g., to determine Tₜᵣₐₙₛₘᵢₜ). For example, transmitter timing module 446 may determine Tₜᵣₐₙₛₘᵢₜ (as described herein) based on timing information and determined by timing information module 444.

FIG. 5 shows an illustrative flow chart depicting an example operation 500 for transmitting data between a first wireless device and a second wireless device, in accordance with some embodiments. The first wireless device may transmit a first data frame that includes timing information associated with the first wireless device to the second wireless device. In response, the second wireless device may transmit a second data frame to the first wireless device based, at least in part, on the timing information. Referring also to FIGS. 1 and 2, the first wireless device transmits the first data frame to the second wireless device (502). The first data frame may include timing information associated with the first wireless device. For example, the timing information may include a scheduled receive time to indicate when a data frame may be received by the first wireless device and a receive duration time when an associated Wi-Fi receiver of the first wireless device may be enabled. In some embodiments, the first wireless device may include timing information within an informational element (such as informational element 300) with the first data frame.

Next, the second wireless device receives the first data frame from the first wireless device (504). As described above, the first data frame may include timing information from the first wireless device. Next, the second wireless device transmits an acknowledgement message to the first wireless device (506). In some embodiments, the acknowledgement message may be transmitted in response to receiving the first data frame. Next, the first wireless device receives the acknowledgement message associated with the first data frame (508).

After transmitting the acknowledgement message at 506, the second wireless device determines the transmit time (e.g., Tₜᵣₐₙₛₘᵢₜ) based, at least in part, on timing information received from the first wireless device (510). For example, timing information from the first wireless device and eq. 5 may be used to determine Tₜᵣₐₙₛₘᵢₜ. Next, the second wireless device may transmit the second data frame to the first wireless device based, at least in part, on the determined Tₜᵣₐₙₛₘᵢₜ time (512). Next, the first wireless device receives the second data frame (514). In some embodiments, the first wireless device may receive the second data frame during a receive opportunity determined by timing information provided by the first wireless device to the second wireless device.

In the foregoing specification, the present embodiments have been described with reference to specific exemplary embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of exchanging data frames between a first wireless device and a second wireless device, the method performed by the first wireless device and comprising:
receiving a first data frame from the second wireless device, the first data frame including timing information;
transmitting an acknowledgement message to the second wireless device based, at least in part, on the first data frame;
determining a transmit time to transmit a second data frame to the second wireless device based, at least in part, on the timing information; and
transmitting the second data frame at the determined transmit time.

2. The method of claim 1, wherein the timing information is included within an informational element received with the first data frame.

3. The method of claim 1 wherein the timing information includes at least one of a next receive time, a receive duration time, and a time of day.

4. The method of claim 1, wherein the timing information includes a field indicating whether the second wireless device is synchronized to a reference clock.

5. The method of claim 4, wherein the reference clock is associated with a Network Time Protocol (NTP).

6. The method of claim 1, wherein the timing information includes a buffer value based, at least in part, on a communication medium congestion or a processing delay associated with receiving the first data frame.

7. The method of claim 1, wherein the first data frame is one of a probe request, a probe response, and an action frame.

8. The method of claim 1, wherein the second data frame is transmitted according to an IEEE 802.11 specification.

9. The method of claim 1, wherein the second data frame is to establish a peer-to-peer network including the first wireless device and the second wireless device.

10. A first wireless device, comprising:
a wireless transceiver;
a processor; and
a memory storing instructions that, when executed by the processor, cause the first wireless device to:
receive a first data frame from a second wireless device, the first data frame including timing information;
transmit an acknowledgement message to the second wireless device based, at least in part, on the first data frame;
determine a transmit time to transmit a second data frame to the second wireless device based, at least in part, on the timing information; and
transmit the second data frame at the determined transmit time.

11. The wireless device of claim 10, wherein the timing information is included within an informational element received with the first data frame.

12. The wireless device of claim 10, wherein the timing information includes a field indicating whether the second wireless device is synchronized to a reference clock associated with a Network Time Protocol (NTP).

13. The wireless device of claim 10, wherein the timing information includes a buffer value based, at least in part, on a communication medium congestion or a processing delay associated with receiving the first data frame.

14. The wireless device of claim 10, wherein the first data frame is one of a probe request, a probe response, and an action frame.

15. The wireless device of claim 10, wherein the second data frame is to establish a peer-to-peer network including the first wireless device and the second wireless device.

16. A non-transitory computer-readable medium storing instructions that, when executed by a processor of a first wireless device causes the first wireless device to:
receive a first data frame from a second wireless device, the first data frame including timing information;
transmit an acknowledgement message to the second wireless device based, at least in part, on the first data frame;
determine a transmit time to transmit a second data frame to the second wireless device based, at least in part, on the timing information; and
transmit the second data frame at the determined transmit time.

17. The non-transitory computer-readable medium of claim 16, wherein the timing information is included within an informational element received with the first data frame.

18. The non-transitory computer-readable medium of claim 16, wherein the timing information includes a field indicating that the second wireless device is synchronized to a reference clock associated with a Network Time Protocol (NTP).

19. The non-transitory computer-readable medium of claim 16, wherein the timing information includes a buffer value based, at least in part, on a communication medium congestion and/or a processing delay associated with receiving the first data frame.

20. The non-transitory computer-readable medium of claim 16, wherein the first data frame is one of a probe request, a probe response, and an action frame.
